(19) United States
(12) Patent Application Publication
(10) Pub. No.: US 2012/0209554 A1
(43) Pub. Date: Aug. 16, 2012

(54) SYSTEM AND METHOD FOR THREE DIMENSION LOCATION DETERMINATION

(75) Inventors: Elliott Hoole, Kirkland, WA (US); Kenneth Arneson, West Richland, WA (US); Perry Satterlee, Kirkland, WA (US)

(73) Assignee: Recon Dynamics, LLC, Kirkland, WA (US)

(21) Appl. No.: 13/371,016

(22) Filed: Feb. 10, 2012

Related U.S. Application Data
(60) Provisional application No. 61/441,371, filed on Feb. 10, 2011.

(51) Int. Cl. G01C 25/00; G06F 15/00; G01L 13/00; G01S 19/40

(52) U.S. Cl. 702/94; 342/357.23; 702/150; 702/138

(57) ABSTRACT

The location of an asset can be determined in three dimensions using pressure data from reference sensors in combination with conventional two-dimensional location technology, such as GPA or TDOA. In a building, reference sensors are distributed on multiple floors and transmit accurate pressure readings to a receiver. The asset also has a pressure sensing element and transmits the pressure at its location to the receiver. The asset pressure value is compared with the reference pressure sensor values to determine the floor in a building on which the asset is located. Thus, the combination of accurate two-dimensional location technology and pressure sensors can accurately determine the location of an asset in three dimensions.

### BACKGROUND OF THE INVENTION

1. Field of the Invention

The present disclosure is related to asset tracking technology, and more particularly, to a system and method for locating the position of an asset in three dimensions.

2. Description of the Related Art

A variety of well-known techniques are used to locate the position of an asset. For example, inventory tracking can use known technology to determine the location of valuable assets. Alternatively, a human being could be considered an asset; locating the position of a human asset can also be important.

A number of known technologies are capable of determining the position of an asset in two dimensions. For example, global positioning system (GPS) technology is widely used to determine the location of an asset. However, GPS location-based technology requires essentially line of sight between the asset to be located and multiple GPS satellites. It is well known that GPS systems do not operate well in urban areas where buildings and other assets block line of sight communication from satellites. In addition, GPS systems can be costly.

Terrestrial-based wireless location systems can produce accurate results in a two-dimensional plane, but commonly employed algorithms struggle to achieve sufficient accuracy to locate assets in the third dimension (i.e., elevation). Terrestrial-based wireless systems typically use a time difference of arrival (TDOA) along with well-known mathematical equations to determine the location of an asset in a two-dimensional plane.

However, locating the position of the asset in the third dimension (i.e., elevation) is often subject to significant errors. Therefore, it can be appreciated that there is a significant need for a system and method to locate an asset in three dimensions. The present invention provides this, and other advantages, as will be apparent from the following detailed description and accompanying figures.

### BRIEF DESCRIPTION OF THE SEVERAL VIEWS OF THE DRAWING(S)

FIG. 1 illustrates the layout of receivers to determine the location of an asset in two-dimensional space.

FIG. 2 is a side view of a building illustrating the position of an asset and reference elevation sensors used to locate the asset in the third dimension.

FIG. 3 is a functional block diagram of a reference elevation sensor illustrated in FIG. 2.

FIG. 4 is a functional block diagram of a receiver system configured to determine the location of an asset in three dimensions.

FIG. 5 is a table illustrating sample pressure readings from multiple sensors.

FIG. 6 is a flow chart illustrating the operation of the system to locate an asset in three dimensional space.

### DETAILED DESCRIPTION OF THE INVENTION

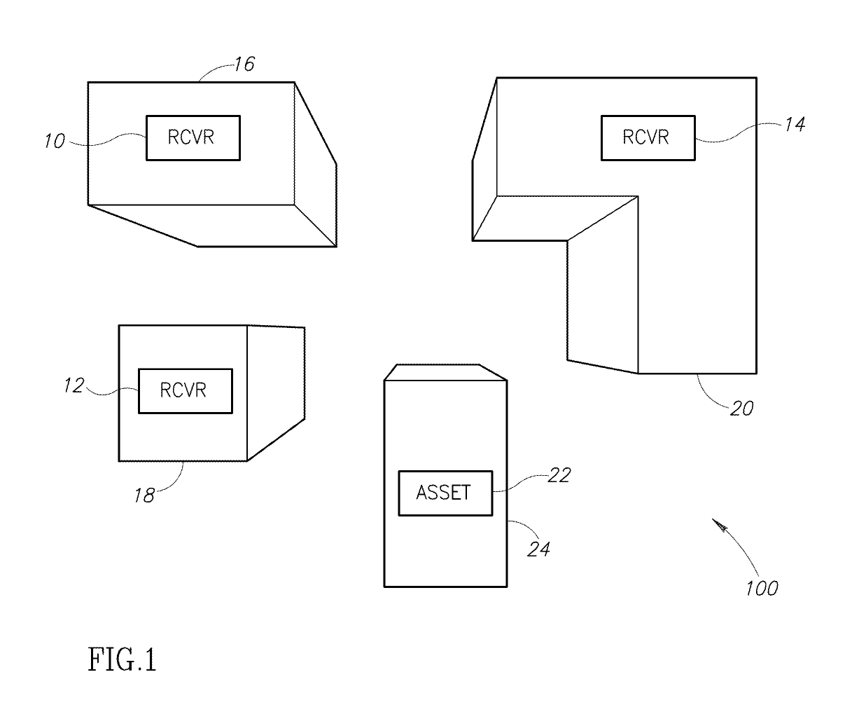

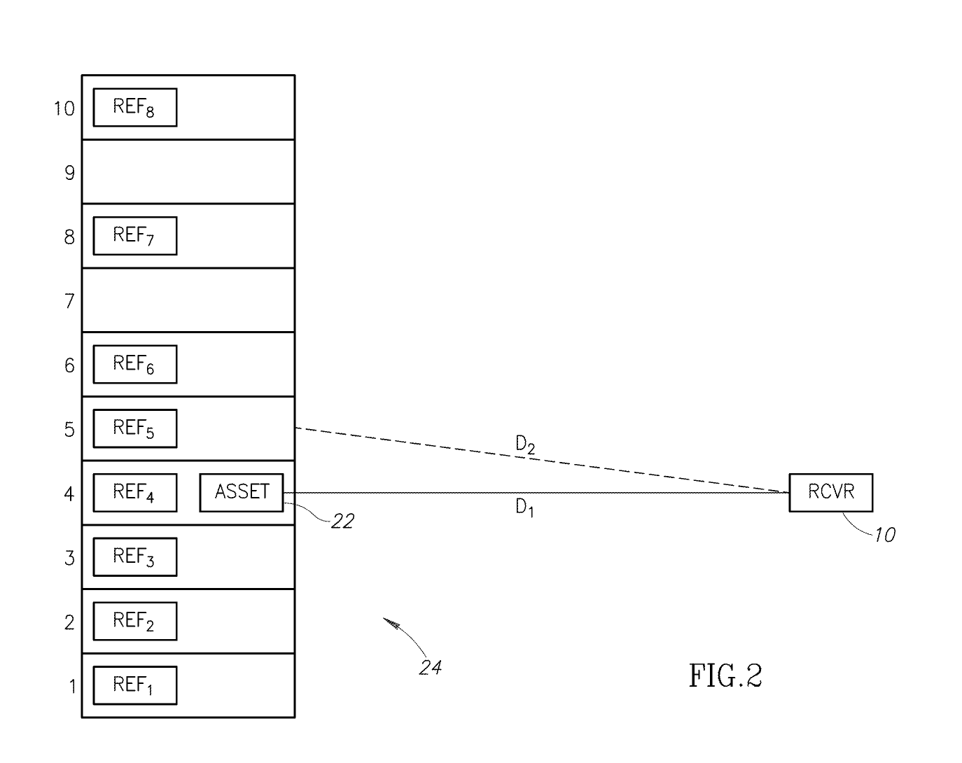

The present disclosure is directed to a system and method for determining the location of an asset in three-dimensional space. Examples of assets are computers, electronic test equipment, printers, projectors, and the like. As noted above, the asset may also include human assets. The present disclosure is not limited to any particular form or type of asset. Conventional systems are capable of determining the location of an asset in two-dimensional space with a high degree of accuracy. However, determining the location of the asset in the third dimension (i.e., elevation) is much more difficult. FIG. 1 illustrates a bird's eye view of several buildings such as may be found in an industrial park, university campus, or the like. In FIG. 1, a system 100 includes receivers 10-14 positioned, by way of example, on the rooftops of buildings 16-20. The location of an asset may be readily determined in two dimensions by the receivers 10-14 based on well-known TDOA algorithms. FIG. 2 illustrates an example of the determination of the location of an asset in three-dimensional space and further illustrates the difficulty of locating the asset in three-dimensional space using conventional TDOA techniques. In FIG. 2, the receivers 10-14 receive a signal transmitted from the asset 22. In the example of FIG. 2, the asset 22 is on the fourth floor of a building 24 and is separated from the receiver 10 by a distance D₁. Using conventional TDOA techniques, the distance between the asset 22 and the receiver 10 can be readily determined. However, if the asset 22 was on the fifth floor rather than the fourth floor in the example of FIG. 2, the asset 22 would be at a distance D₂ from the receiver 10. In most circumstances, the distance between the receiver 10 and the building 24 is significantly greater than the distance between floors in the building. For example, if the distance D₁ equals 500 feet, and the distance between the fourth floor and the fifth floor is 15 feet, simple mathematics will demonstrate that the distance D₂ is 500.2 feet. With the radio signal from the asset 22 traveling at the speed of light, it covers approximately one foot per nanosecond. With the difference in elevation between the fourth floor and the fifth floor, the conventional TDOA system would require an accuracy of less than 0.1 nanoseconds to distinguish between the distance D₁ and D₂ in FIG. 2. Conventional TDOA systems generally have an accuracy of approximately ±10 nanoseconds. Thus, conventional TDOA systems are incapable of distinguishing the location of the asset 22 on a particular floor in a building.

To overcome this deficiency, the system 100 employs conventional two-dimensional technology along with a series of elevation sensors to provide data regarding the elevation of the asset 22. The system 100 can employ conventional GPS technology or conventional TDOA technology to provide the two-dimensional location of the asset 22. One example of TDOA technology is provided in U.S. Pat. No. 7,339,522, which is assigned to the assignee of the present disclosure.

As will be described in greater detail below, the system 100 determines the two-dimensional location of the asset and uses a barometric pressure reading from the asset 22 to determine its elevation. While it is possible to use only a single barometric sensor in the asset 22, such an approach does not have sufficient accuracy. Changes in atmospheric pressure due to normal weather conditions (i.e., high pressure and low pressure weather fronts) cause changes in barometric pressure that are generally much larger than the pressure difference caused by elevation within a building. For example, a typical pressure sensor will provide approximately 0.36 millibars of pressure change for each floor in the building. In contrast, changes from low to high pressure resulting from normal weather conditions far exceed that value. Thus, one could never be certain whether a certain pressure reading is a result of the location of the asset 22 or simply the result of changing atmospheric conditions.

To overcome this problem, the system 100 utilizes a series of small pressure sensors deployed in remote devices. FIG. 2 illustrates a plurality of reference pressure sensors Ref₁-Ref₈ deployed on different floors in the building 24. In one embodiment, a different reference sensor is located on each floor of the building. Alternatively, the reference sensors may be distributed throughout the building, for example, on alternating floors.

Each of these reference sensors transmits a pressure reading back to the receivers (e.g., the receiver 10). In addition, the asset 22 transmits a reading from its pressure sensor. The pressure sensor reading from the asset 22 will match one of the pressure readings from the reference sensors Ref₁-Ref_{8.} By selecting the reference pressure value closest to the pressure sensor reading from the asset 22, the location of the asset 22 on a particular floor in a building 24 can be readily determined.

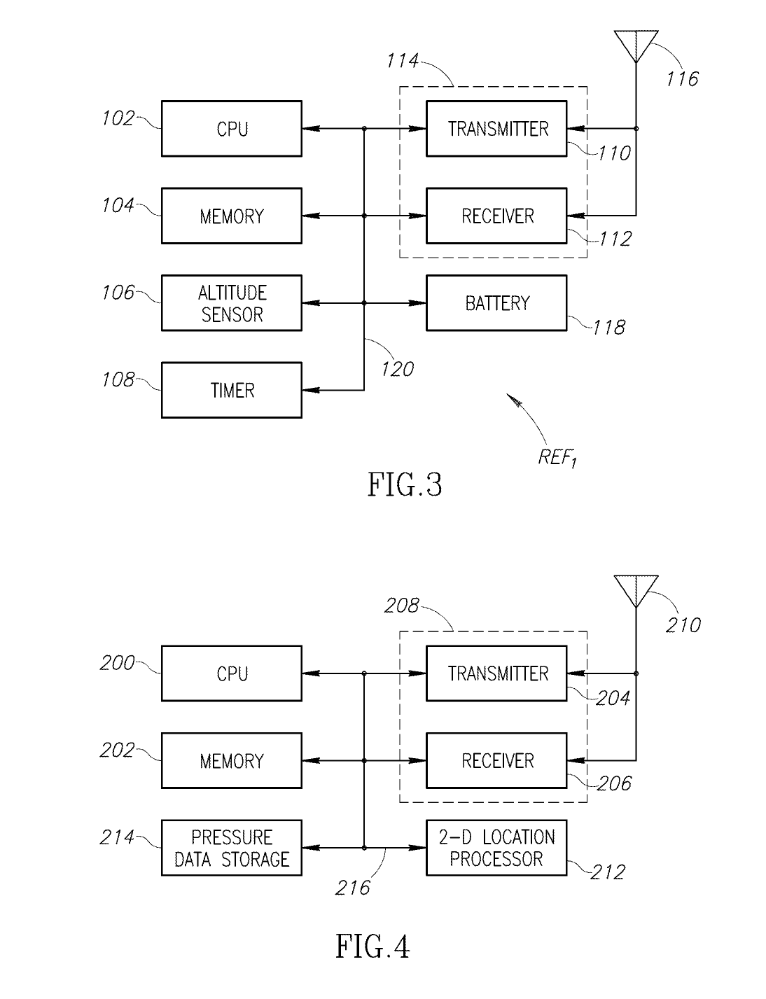

FIG. 3 is a functional block diagram of the reference sensor Ref₁. The other pressure sensors (i.e., Ref₂-Ref₈ are functionally equivalent to the sensor Ref₁). The reference sensor Ref₁ includes a CPU 102 and a memory 104. In general, the CPU receives instructions and data from the memory 104 and executes those instructions using the supplied data. The CPU 102 may be implemented by any conventional form, such as a micro-processor, micro-controller, programmable gate array, application-specific integrated circuit, digital signal processor, or the like. The system 100 is not limited by the specific implementation of the CPU 102.

Similarly, the memory 104 may be implemented using one or more of a variety of known technologies, such as random access memory, read-only memory, programmable memory, flash memory, and the like. In one embodiment, a portion of the memory 104 may be integrated into the CPU 102. The memory 104 is not limited by any particular implementation.

The reference sensor Ref₁ also includes an altitude sensor 106, which may be typically implemented as a barometric sensor. The altitude sensor 106 is a commercial device and, in a typical embodiment, has a sensor accuracy of ±0.01 millibars. A timer 108 may be used by the reference sensor Ref₁ to control the timing of a sensor reading and the current pressure value. The timer 108 may be an external device, a hardware component of the CPU, or may be implemented as a set of instructions stored in the memory 104 and executed by the CPU 102.

The reference sensor Ref₁ also includes a transmitter 110 and an optional receiver 112. In some embodiments, the transmitter 110 and receiver 112 may share circuitry and may be implemented as a transceiver 114. The transceiver 114 is coupled to an antenna 116. A number of known transceiver technologies may be used to implement the transceiver 114. In an exemplary embodiment, the transceiver 114 operates in the 900 MHz ISM band. The transceiver 114 uses direct-sequence spread spectrum modulation to create a signal with a modulated bandwidth of 10 MHz. The transmitted power is approximately 1 watt. Under good propagation conditions, the signal may propagate several miles. In a more typical environment, ground clutter and signal blockage due to building penetration may result in a typical range of 1 mile used in most deployment plans for the system 100.

The reference sensor Ref₁ also includes a battery 118 to provide power to the various components. The building 24 may supply AC power to the reference sensor Ref₁ to replace the battery 118 or the battery may be included as a back-up power source.

The various components illustrated in FIG. 3 in the functional block diagram of FIG. 3 are coupled together by a bus system 120, which may include a data bus, address bus, control bus, power bus, and the like. For the sake of simplicity, those various busses are illustrated in FIG. 3 as the bus system 120.

In an alternative embodiment, two or more of the reference sensors Ref₁-Ref₈ may use a single transmitter 110. In the example of FIG. 2, the reference sensors Ref₁-Ref₈ may be coupled together using conventional wired technology (e.g., Ethernet, RS-232, or the like), fiber optic cables, or wireless technology (e.g., WiFi, Bluetooth, Zigbee or the like). The reference sensors Ref₁-Ref₈ would then require only a single transmitter 110, which may be integral to one of the reference sensors (e.g., the reference sensor Ref₈ near the top of the building 24) to transmit the data for all of reference sensors Ref₁-Ref₈. Alternatively, there may be separate transmitters for every two or three of the reference sensors Ref₁-Ref₈.

As noted above, the reference sensor Ref₁ periodically performs pressure sensor measurements and transmits the data using the transmitter 110. The timer 108 may have a pre-programmed timing value or may be programmed by the user. Pressure readings once per hour may be satisfactory. However, those skilled in the art will appreciate that the value from the timer may be altered to provide pressure measurements more or less frequently. Less frequent pressure measurements will help conserve power in the battery 118.

In an alternative embodiment, the reference sensors Ref₁-Ref₈ may be configured to automatically transmit new pressure data when the pressure has changed by a predetermined amount. For example, an initial pressure reading may be saved when it is first transmitted. Subsequent pressure reading can be compared to the initial pressure reading and the transmitter 110 need only transmit new pressure readings if the current pressure changes by a predetermined percentage (e.g., 10%) or changes by some fixed amount (e.g., 0.20 millibars).

In yet another alternative embodiment, the reference sensor Ref₁ may include the receiver 112. In this embodiment, the receiver 10 (or any other receiver) may transmit a query signal to the reference sensors Ref₁-Ref₈ to trigger a pressure reading operation. Although this implementation requires the extra cost of the receiver 112, the reference sensor Ref₁ may operate in a very low power (sleep mode) and periodically enter an active or “awake” mode to listen for a query from one of the receivers 10-14. This query may be referred to as a page, poll or other conventional term, but effectively wakes up only for a brief period of time to determine whether a pressure reading has been requested.

Those skilled in the art will appreciate that the asset 22 itself also has a remote device attached thereto. For purposes of explaining the principles of the present disclosure, the remote device attached to the asset 22 is essentially identical to the reference sensor Ref₁ illustrated in FIG. 3.

In operation, the reference sensors Ref₁-Ref₈ provide pressure data for their respective locations. The asset 22 also provides pressure data for its unknown location. The two-dimensional location is determined in a conventional manner and the pressure reading from the asset 22 is compared with pressure readings from the reference sensors Ref₁-Ref₈ to determine the elevation of the asset.

FIG. 4 illustrates a functional block diagram of the receiver 10. Those skilled in the art will appreciate that the other receivers (12-14) have similar functionality and may be implemented in a like fashion. The receiver 10 includes a CPU 200 and a memory 202. As discussed above with respect to the CPU 102 in FIG. 3, the CPU 200 may be implemented using a variety of known technologies. The CPU 200 is not limited to any specific implementation. Similarly, the memory 202 may be implemented using one or more known technologies, as discussed above with respect to the memory 104.

The receiver 10 also includes a transmitter 204 and a receiver 206. The transmitter 204 and receiver 206 may share circuitry and be implemented as a transceiver 208. The transceiver 208 is coupled to an antenna 210. The operation of the transceiver 208 for two-dimensional location technology is well known in the art and need not be described in greater detail herein.

The receiver 10 also includes a two-dimensional location processor 212. As described above, the two-dimensional location processor 212 uses conventional technology to determine the location of an asset in two dimensions. The two-dimensional processor 212 may use GPS technology or TDOA technology to accurately determine the location of the asset 22.

In addition, the receiver 10 is altered in accordance with the present disclosure to include a pressure data storage area 214. The pressure data storage area 214 contains pressure data from the reference sensors Ref₁-Ref₈. The pressure data storage area 214 will contain data identifying the various reference sensors (e.g., the reference sensors Ref₁-Ref₈), the location of each reference sensor, and the current pressure reading from each sensor. Those skilled in the art will appreciate that the pressure data storage area 214 may be satisfactorily implemented as any data structure such as a table, spreadsheet, database, or the like. The pressure data storage area 214 is not limited to a particular embodiment. In one embodiment, the pressure data storage area 214 may be implemented as part of the memory 202.

The various components illustrated in the functional block diagram of FIG. 4 are coupled together by a bus system 216. The bus system 216 may include an address bus, a data bus, control bus, power bus, and the like. For the sake of simplicity, those various busses are illustrated in FIG. 4 as the bus system 216.

Those skilled in the art will appreciate that the components illustrated in the functional block diagrams of FIGS. 3 and 4 may be implemented as set of instructions or data stored in the memory (i.e., the memory 104 or the memory 202) and executed by the respective CPUs 102 and 200. For example, the timer 108 in FIG. 3 may be implemented as a set of instructions executed by the CPU 102. Similarly, the data pressure storage area 214 may be a part of the memory 202 while the two-dimensional location processor 212 may be implemented as a set of instructions stored in the memory 202 and executed by the CPU 200. These elements are illustrated as separate components in the functional block diagrams of FIGS. 3-4 because they each perform separate functions.

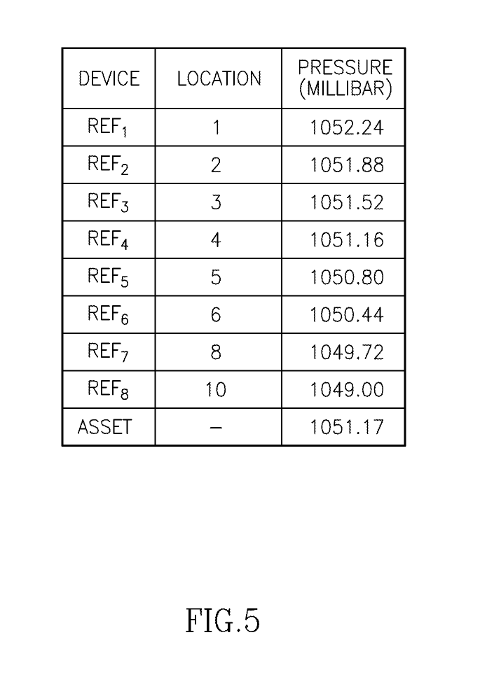

FIG. 5 illustrates a sample pressure data table of the pressure data storage area 214 for the reference sensors Ref₁-Ref₈, which are positioned in known locations, as well as the sample pressure readings for each of the respective sensors. At the bottom of the table in FIG. 5, the pressure reading from the asset 22, whose location is unknown, is also illustrated. The pressure reading for the asset 22 is compared to the pressure readings for the reference sensors to determine a match. In the present example, the pressure reading from the asset 22 is within 0.01 millibars of the pressure reading from the reference sensor Ref₄, located on the fourth floor of the building 24 identified by two-dimensional location technology as the location of the asset. Thus, the location of the asset is determined in three dimensions.

In operation, the various receivers (i.e., the receivers 10-14) receive a signal transmitted from the asset 22. Using conventional technology, such as TDOA, the receivers 10-14 determine the time of arrival of the signal at each of the respective receivers. Conventional algorithms are used to determine the precise two-dimensional location of the asset 22. In the example illustrated in FIGS. 1 and 2, the asset is located somewhere in the building 24. Thus, the system 100 will use the reference sensors Ref₁-Ref₈ distributed in the building 24 to determine the floor on which the asset 22 is located. Those skilled in the art will appreciate that other buildings (e.g., the buildings 16-20) may also have reference sensors (not shown) distributed throughout. However, these sensors need not be used once it is determined that the asset is located in the building 24. The receiver 10 receives the current pressure reading from the asset 22. As previously discussed, the asset 22 may periodically transmit its pressure reading or do so in response to a query from the receiver 10. The pressure reading from the asset 22 is compared to the pressure readings from the reference sensors Ref₁-Ref₈ to determine the location of the asset.

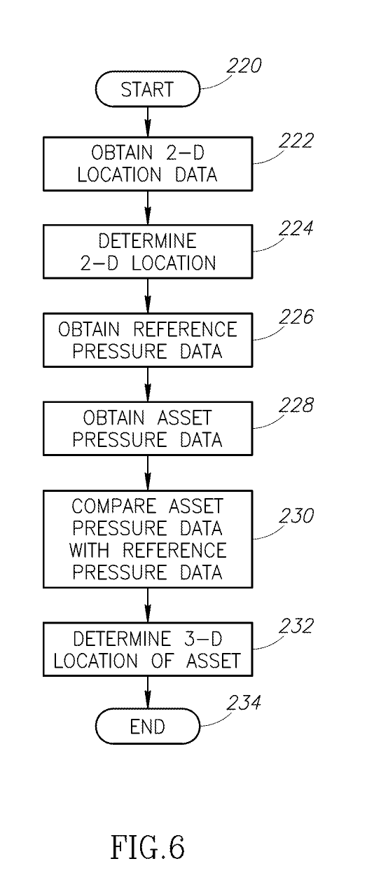

FIG. 6 is a flow chart illustrating the operation of the system 100. At a start 220, the reference sensors have been distributed throughout the region of interest and are active. As previously discussed, the location of each reference sensor is known and stored in the table of FIG. 5.

In step 222, the system 100 obtains the two-dimensional location data using one or more conventional 2-D location technologies. In step 224, the system 100 determines the two-dimensional location of the asset 22. In the example illustrated herein, the asset is located somewhere in the building 24. Therefore, the reference sensors in the building 24 (i.e., the reference sensors Ref₁-Ref₈) will be used to determine the elevation of the asset 22.

In step 226, the system 100 obtains reference pressure data from the reference sensors Ref₁-Ref₈. In step 228, the system 100 obtains pressure data from the asset 22. In step 230, the system 100 compares the asset pressure data with the reference pressure data in the table of FIG. 5, and in step 232, the system 100 determines the location of the asset 22 in three dimensions. The process ends at 234.

Those skilled in the art will appreciate that a number of different implementations may be satisfactorily employed with the system 100. For example, if the reference sensors are not on each floor, the pressure readings may be interpolated to determine the precise location of the asset 22. For example, in FIG. 2, reference sensors Ref₇ and Ref₈ are located on floors 8 and 10 respectively. If the asset 22 is on floor 9, the pressure reading from the asset will be approximately half way between the pressure readings from the reference sensors Ref₇-Ref₈.

The system 100 also permits a calibration process. Both the asset sensor and the reference sensors can be calibrated. In one embodiment, all reference sensors may be calibrated to have the same reading prior to installation. For example, the sensors could all be calibrated at ground level and then installed in the various locations on different floors throughout the building (e.g., the building 24 in FIG. 2). In an alternative embodiment, the reference sensors may be calibrated after installation. For example, if reference sensors are installed in the same location on each floor of the building, one would expect to see a substantially uniform change in pressure from the reference sensors on each successive floor of the building 24. If one or more of the sensors has a reading that is not indicative of such uniform changes in pressure, it is possible to calibrate that sensor to provide the desired pressure reading to thereby provide substantially uniform changes from one floor to another.

In addition, the pressure sensor from the asset 22 can also be calibrated. For example, if the asset is initially positioned in a known location, such as the fourth floor in the example of FIG. 2, the pressure sensor in the asset 22 can be adjusted to equal the pressure value from the reference sensor REF₄ on that floor.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for determining an asset location, comprising:
an asset altitude sensor affixed to the asset and configured to generate altitude data;
an asset transmitter affixed to the asset and configured to transmit a signal, including the altitude data from the altitude sensor;
a two-dimensional position determination system configured to detect the transmitted signal and to determine the location of the asset in two dimensions based on the signal;
a plurality of reference altitude sensors positioned in known geographic locations and elevations proximate the asset and configured to generate altitude data;
a reference transmitter associated with the plurality of reference altitude sensors and configured to transmit the altitude data generated by the respective reference altitude sensor, wherein an elevation of the asset is determined based on an altitude difference between the altitude data from the asset altitude sensor and the altitude data from one or more of the plurality of reference altitude sensors.

2. The system of claim 1, further comprising a satellite positioning system affixed to the asset wherein the signal transmitted by the asset transmitter comprises satellite-based position data and the two-dimensional position determination system uses the satellite-based position data to determine the location of the asset in two dimensions.

3. The system of claim 1 wherein the two-dimensional position determination system comprises a plurality of receivers that are configured to determine the location of the asset in two dimensions using a time difference of arrival of the signal transmitted by the asset transmitter.

4. The system of claim 1 wherein the reference transmitter comprises a separate reference transmitter for each of the plurality of reference altitude sensors.

5. The system of claim 1 wherein the reference transmitter comprises a single reference transmitter for more than one of the plurality of reference altitude sensors.

6. The system of claim 1 wherein the reference transmitter is configured to periodically transmit the altitude data generated by the respective altitude sensors.

7. The system of claim 1, further comprising a receiver associated with reference transmitter and configured to receive a command wherein the reference transmitter is configured to transmit the altitude data generated by the respective altitude sensors upon reception of the command from the receiver.

8. The system of claim 1 wherein each of the plurality of altitude sensors comprises a barometric pressure sensor and the reference transmitter is configured to transmit the altitude data generated by the respective altitude sensors if the barometric pressure changes by a predetermined amount.

9. The system of claim 1 wherein the elevation of the asset is determined based on matching the altitude data from the asset altitude sensor to the altitude data one of the plurality of reference altitude sensors having altitude data that most closely matches the asset altitude sensor data.

10. The system of claim 1 wherein one of the plurality of reference altitude sensors is mounted of every floor of a building and the elevation of the asset is determined to be on a particular floor of the building by identifying the floor for which the reference altitude sensor has altitude data that most closely matches the asset altitude sensor data.

11. The system of claim 1 wherein one of the plurality of reference altitude sensors is mounted on spaced apart floors of a building and the elevation of the asset is determined to be on a particular floor of the building when the reference altitude sensor for that particular floor has altitude data that matches the asset altitude sensor data or by interpolating reference sensor altitude data if the asset altitude sensor data value falls between the altitude data values for two adjacent reference altitude sensors.

12. The system of claim 1 wherein each of the plurality of altitude sensors comprises a barometric pressure sensor and the altitude data is barometric pressure data.

13. The system of claim 1 wherein each of the plurality of altitude sensors is an adjustable sensor to permit calibration of the reference altitude sensors.

14. The system of claim 1 wherein asset altitude sensor is an adjustable sensor to permit calibration of the asset altitude sensor.

15. A system for determining an asset location, comprising:
an asset pressure sensor affixed to the asset and configured to generate barometric pressure data;
an asset transmitter affixed to the asset and configured to transmit a signal, including the barometric pressure data from the asset pressure sensor;
a two-dimensional position determination system configured to detect the transmitted signal and to determine the location of the asset in two dimensions;
a reference pressure sensor positioned in a known geographic location proximate the asset and configured to generate barometric pressure data;
a reference transmitter associated with the reference pressure sensor and configured to transmit the barometric pressure data generated by the reference pressure sensor, wherein an elevation of the asset is determined based on a difference between the barometric pressure data from the asset pressure sensor and the barometric pressure data from the reference pressure sensor.

16. The system of claim 15, further comprising a plurality of reference pressure sensors positioned in known geographic locations and at different known elevations proximate the asset and configured to generate barometric pressure data wherein the reference wherein the reference transmitter is further configured to transmit the barometric pressure data generated by each of the plurality of reference pressure sensors.

17. The system of claim 15, further comprising:
a plurality of reference pressure sensors positioned in known geographic locations and at different known elevations proximate the asset and configured to generate barometric pressure data; and
a plurality of reference transmitters with one reference transmitter for each reference pressure sensor wherein each of the plurality of reference transmitters is configured to transmit the barometric pressure data generated by a corresponding one of the plurality of reference pressure sensors.

18. The system of claim 15 wherein the reference transmitter is configured to periodically transmit the barometric pressure data generated by the respective reference pressure sensors.

19. The system of claim 15, further comprising a receiver associated with reference transmitter and configured to receive a command wherein the reference transmitter is configured to transmit the barometric pressure data generated by the respective reference pressure sensors upon reception of the command from the receiver.

20. The system of claim 15 wherein the reference transmitter is configured to transmit the reference pressure generated by the respective reference pressure sensors if the barometric pressure changes by a predetermined amount.

21. A method for determining an asset location, comprising:
generating asset barometric pressure data indicating a barometric pressure at the location of the asset;
transmitting a signal from the asset, including the asset barometric pressure data;
generating reference barometric pressure data indicating a barometric pressure at a known location proximate the asset;
transmitting the reference barometric pressure data;
from a location remote from the location of the asset, determining the location of the asset in two dimensions based on the transmitted signal from the asset; and
determining the location of the asset in a third dimension based on a difference between the asset barometric pressure data and the reference barometric pressure data.

22. The method of claim 21, further comprising:
generating reference barometric pressure data indicating a barometric pressure at a plurality of known altitudes;
transmitting the reference barometric pressure data indicating the barometric pressure at a plurality of known altitudes; and
determining the location of the asset in the third dimension by selecting one of the known altitudes whose barometric pressure most closely matches the asset barometric pressure.

23. The method of claim 22, further comprising adjusting each of a plurality of reference pressure sensors to thereby adjust the reference barometric pressure data at each of the plurality of known altitudes.

24. The method of claim 22, further comprising adjusting an asset pressure sensor to thereby adjust the asset barometric pressure data.

25. The method of claim 21 wherein transmitting the reference barometric pressure data is performed periodically.

26. The method of claim 21, further comprising receiving a query command wherein transmitting the reference barometric pressure data is performed upon reception of the query command.

27. The method of claim 21, further comprising storing an initial reference barometric pressure data value, calculating a new reference barometric pressure data value, comparing the new reference barometric pressure data value with the initial reference barometric pressure data value wherein transmitting the reference barometric pressure data is performed if the new reference barometric pressure data value has changed from the initial reference barometric pressure data value by a predetermined amount.

28. The method of claim 21, further comprising adjusting a reference pressure sensor to thereby adjust the reference barometric pressure data.

29. The method of claim 21, further comprising adjusting an asset pressure sensor to thereby adjust the asset barometric pressure data.
